(19) United States
(12) Patent Application Publication
(10) Pub. No.: US 2003/0114117 A1
(43) Pub. Date: Jun. 19, 2003

(54) Tunable RF signal generation

(76) Inventors: Yee Loy Lam, Singapore (SG); Jianping Yao, Ottawa (CA); Yan Zhou, Pleasanton, CA (US)

Correspondence Address: PERMAN & GREEN, 425 POST ROAD, FAIRFIELD, CT, 06824, US

(21) Appl. No.: 10/288,723

(22) Filed: Nov. 6, 2002

Related U.S. Application Data
(60) Provisional application No. 60/337,722, filed on Nov. 7, 2001.

(51) Int. Cl. H04B 1/40

(52) U.S. Cl. 455/77; 455/150.1

(57) ABSTRACT

There is provided a tunable radio frequency (RF) signal generator comprising: a bi-directional ring laser and a photodetector. The ring laser includes a phase modulator driven by an electrical signal. In use, the modulator imparts a phase shift in dependence on the electrical signal to at least one of a mutually coherent clockwise and counter-clockwise propagating optical signal in the ring laser so as to produce a predetermined difference in the frequency of the clockwise and counter-clockwise propagating signals. The photodetector is optically coupled to an optical output of the ring laser, and in use the photodetector generates a radio frequency signal in dependence on the difference in frequency of the clockwise and counter-clockwise propagating optical signals.

There is also provided a method for generating a tunable radio frequency signal using the tunable radio frequency (RF) signal generator.

### CROSS-REFERENCE TO RELATED APPLICATION

This application claims the benefit of U.S. provisional application No. 60/337,722 filed Nov. 7, 2001, which is incorporated by reference herein in its entirety.

### FIELD OF THE INVENTION

The present invention relates to the generation of a tunable radio frequency (RF) signal using a photonic source.

### BACKGROUND TO THE INVENTION

Photonic technology offers many advantages over its electronic counterpart: low loss, light weight, high frequency, high security, and immunity to electromagnetic interference. For this reason, there is an increasing interest in radio frequency (RF) microwave photonics in applications such as telecommunications, radar and electronic warfare.

RF signals are conventionally generated using electronics by multiplying a low frequency to a high frequency with several stages of multipliers and amplifiers. Consequently, the system is bulky, complicated, inefficient, high phase noise and costly. Two techniques have been recently proposed to generate RF signal using photonics. One approach is to generate two coherent light waves by injection locking two lasers. Another approach is to generate two coherent light waves by phase locking two lasers. The RF signal is obtained by beating the two waves at a photodetector. However, these approaches require the use of two separate lasers. In addition, to achieve injection or phase locking, an RF signal is required as a reference. Therefore, these techniques can only be of use for RF signal distribution, but not for RF signal generation.

### SUMMARY OF THE INVENTION

According to the present invention, a tunable radio frequency (RF) generator comprises:

a bidirectional ring laser, the ring laser including: a phase modulator driven by an electrical signal, in use the modulator imparting a phase shift in dependence on the electrical signal to at least one of a mutually coherent clockwise and counter-clockwise propagating optical signal in the ring laser so as to produce a predetermined difference in the frequency of the clockwise and counter-clockwise propagating signals; and,

a photodetector optically coupled to an optical output of the ring laser, in use the photodetector generating a radio frequency signal in dependence on the difference in frequency of the clockwise and counter-clockwise propagating optical signals.

The RF generation system according to the present invention uses a single ring laser, in which two mutually-coherent, counter-propagating optical signals are generated by laser action. The two optical signals have a wavelength difference induced by a phase modulator that lies within the frequency range corresponding to microwave or millimeter wave radiation. The wavelength difference of the two counter-propagating signals is realized by the intra-cavity phase modulator imparting a differential phase shift to the two signals, equivalent to the clockwise and the counter-clockwise signals experiencing a different local refractive index and hence a different effective cavity length. This in turn leads to a slight difference in the lasing frequency of the two optical signals. The temporal form and magnitude of the phase shift can be controlled via the electrical signal driving the phase modulator. An optical output comprising the two optical signals is obtained from the laser via an output coupler and then coupled to a suitably fast photodetector. The photodetector heterodynes the two optical signals to generate an electrical signal that contains a time-varying component at the difference beat frequency of the two optical signals, namely a radio frequency signal.

Preferably, the phase modulator modulates at a frequency substantially the same as a round-trip frequency of the ring laser or a sub-multiple thereof. If the laser is operated continuous-wave (CW) then a CW RF signal will be generated.

Preferably, the cavity is sufficiently short to promote single longitudinal mode operation. This will ensure a stable, well-defined frequency for RF generation. Alternatively, the ring laser may be operated mode-locked in order to ensure mutual coherence between the clockwise and counter-clockwise optical signals and also to repetitively generate short optical pulses, which in turn leads to pulsed RF generation.

Preferably, the laser is mode-locked by means of an intra-cavity intensity modulator, which modulates optical loss in the cavity at the round-trip frequency of the cavity.

The RF generator advantageously further comprises a Bragg reflector optically coupled to an optical output from the ring laser, the Bragg reflector reflecting a portion of the optical spectrum of the optical output back into the ring laser. The Bragg reflector acts as a very narrow bandwidth wavelength filter.

Alternatively, or additionally, the ring laser in the RF generator includes a 2×2 optical coupler. A 2×2 coupler is used both as an output coupler for the laser and as the port to direct the light wave to a Bragg reflector (where present) to reflect a very narrow bandwidth lightwave.

The phase modulator may modulate at a frequency substantially the same as a round-trip frequency of the ring laser or a sub-multiple thereof. The phase modulator may impart a constant phase shift or alternatively a time-varying phase shift.

One example of a modulation that imparts a time varying phase shift is a sawtooth signal. The sawtooth signal is applied to the phase modulator for RF frequency tuning. The phase shift is proportional to the slope of the sawtooth signal. So, the frequency tuning is achieved by simply adjusting the slope of the sawtooth signal applied to the phase modulator. Other examples of modulation signal waveforms include a continuous wave (CW) and a chirped pulse train.

The CW waveform may be used in reduced length cavities when single moded lasing is implemented in both clockwise and counter-clockwise directions.

Since the two (oppositely directed) waves share the same cavity they are substantially coherent. It is noted that in this case no intensity modulator is then required.

The chirped pulse train is a frequency modulated signal and has application in pulse compression techniques in radar systems.

### BRIEF DESCRIPTION OF THE DRAWINGS

Examples of the present invention will now be described in detail with reference to the accompanying drawings, in which:

FIG. 1 shows a first embodiment of a RF generator using fibre-optic components.

FIG. 2 shows a second embodiment of a RF generator, which employs a photonic integrated circuit.

### DETAILED DESCRIPTION

The system can be implemented using fiber optics, photonic integrated circuits, or free-space optics. Here the implementation examples using fiber optics, photonic integrated circuit will be discussed.

Fibre Optic Embodiment

An Er-doped fiber quasi-ring laser incorporating a fiber Bragg grating (FBG) can be made to lase bi-directionally. The bi-directional light waves are derived from the same cavity and mode locking ensures a fixed phase relationship between the two counter-propagating light wave pulses, with the FBG acting as a very narrow bandwidth wavelength filter. As a result, the two counter-propagating waves are expected to be highly coherent.

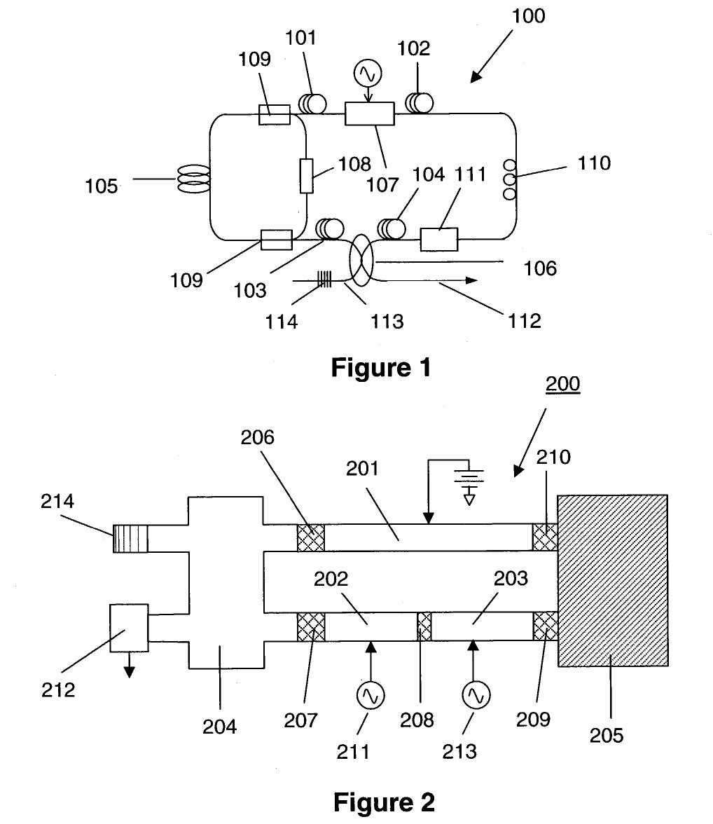

FIG. 1 shows that the configuration and the components used in the fiber optic ring laser 100. There are four equal length fiber loops 101-104 to separate the quasi-ring into four parts. The first function of the fiber loops 101-104 is to control the total cavity length, which will determine the repetition rate of the mode-locked optical pulses. The second function is to enable the two counter propagating pulse waves to reach the Er fiber section 105 at different times in order to avoid mode competition and also to enable the two pulses to meet at the 2×2 fiber coupler 106 with the control of the intensity modulator 107. The Er-doped silica optical fiber 105 can have a typical length of about 10 to 15 meters. To increase the optical pump efficiency, the Er-doped fiber 105 can be pumped in dual directions by a 980 nm diode laser 108 through two 980/1550 nm wavelength division multiplexers (WDM) 109. The polarization controller 110 is used in the cavity because such a laser is polarization dependent and therefore polarization control is preferred. Another choice is to use polarization maintaining (PM) fibers and components. The phase modulator 111 is used to modulate the effective cavity length with significant amplitude and at a fast enough rate so that the clockwise pulse and the counter-clockwise pulse will always see a different refractive index and hence a different effective cavity length. The coupler 106 is used as the output coupling port 112 for the fiber laser as well as the port 113 to direct the light wave to the FBG 114 to reflect a very narrow bandwidth of wavelength.

The intensity modulator and the phase modulator must be modulated in synchronization at the round-trip frequency or its multiples. The intensity modulator 107 will allow the two counter-propagating pulses to pass through it at the same time, but they will reach the phase modulator 111 at different times and hence the phase modulator should be modulated with a square wave in such a way that the two counter propagating pulses will see a different refractive indices. Also note that the two counter-propagating pulses will travel through the Erbium-doped fiber section 105 at different time, they will thus be amplified at different times and this will ensure that there is no mode competition or lock-in effect. However, the two counter-propagating pulses will reach the coupler 106 at the same time and so will beat together, with the difference beat frequency being in the RF frequency range. If the optical signal then impinges on a sufficiently fast photodetector, an electrical signal will be generated at the RF difference frequency.

Photonic Integrated Circuit Embodiment

The present invention can be implemented using a photonic integrated circuit (PIC), which may be based on the Silica-on-Silicon (SOS) integrated optics technology with hybrid active devices; or based on III-V Compound Semiconductor PIC technology. For the latter, one possible approach is illustrated in FIG. 2, where the material system is InGaAsP quantum well epilayers on an InP substrate, and the waveguides are ridge waveguides. With the use of selective area bandgap techniques, including regrowth, selective area growth or selective area multiple-bandgap quantum well intermixing, it is possible to create sections in the PIC with different bandgaps. As such, it permits different sections of the PIC to possess the appropriate bandgaps, such that with respect to the operating wavelength, these sections would function properly either as a passive waveguide (206, 207, 208, 209, 210), an electro-optic phase modulator 202, an electro-absorption modulator 203, a laser gain section 201 or a photodetector 212. There is no need for polarization control as the waveguides are highly birefringent.

As illustrated in FIG. 2, the required ring laser cavity 200 is formed with a laser gain section 201, a phase modulator 202, an intensity modulator 203 and a 2×2 multimode interference (MMI) coupler 204. An optical path length extender 205 may also be included in order to reduce the mode locking frequency. This length extender may be implemented via an external optical fiber, a resonator loop, or a PIC waveguide loop with turning mirrors. The chief advantage of implementation using a PIC is a very significant reduction of size, as the overall size length and width is in a few mm order of magnitude.

By analogy with the fiber optic embodiment, the 2×2 MMI coupler 204 is coupled to both the photodetector 212 and a Bragg grating 214, the later component reflecting signals in a narrow wavelength band. A phase modulation signal generator 211 applies either time-constant or time varying modulation signals to the electro-optic phase modulator 202. Likewise a mode-locking signal generator 213 applies a mode-locking signal to the electro-absorption intensity modulator 203.

In use, the above-described embodiments generate tunable microwave or millimeter wave signals using a single laser. In an important aspect of the invention, a ring laser is used to generate two mode-locked counter-propagating waves, which have a wavelength difference falling in the microwave or millimeter wave frequency range. The wavelength difference of the two waves is achieved by inserting a phase modulator into the laser ring.

The RF frequency is obtained by beating the two counter-propagating waves at the photodetector. The frequency tuning is achieved by adjusting the slope of the sawtooth signal applied to the phase modulator. The proposed system can be implemented using fiber optics, photonic integrated circuitry, or free-space optics.

In an alternative aspect of the invention, the ring laser is used to generate two counter-propagating waves with a microwave or millimeter range wavelength difference, the waves however not necessarily being mode-locked. As mentioned above, the use of a CW waveform allows modulation of the wavelength difference in counter-propagating waves without mode-locking the cavity, the intensity modulator being switched off in this case.

What is claimed is:

1. A tunable radio frequency (RF) generator comprising:
a bi-directional ring laser, the ring laser including: a phase modulator driven by an electrical signal, in use the modulator imparting a phase shift in dependence on the electrical signal to at least one of a mutually coherent clockwise and counter-clockwise propagating optical signal in the ring laser so as to produce a predetermined difference in the frequency of the clockwise and counter-clockwise propagating signals; and,
a photodetector optically coupled to an optical output of the ring laser, in use the photodetector generating a radio frequency signal in dependence on the difference in frequency of the clockwise and counter-clockwise propagating optical signals.

2. An RF generator according to claim 1, in which the bi-directional ring laser is mode-locked.

3. An RF generator according to claim 2, in which the ring laser is mode-locked by means of an intensity modulator.

4. An RF generator according to claim 1, further comprising a Bragg reflector optically coupled to an optical output from the ring laser, the Bragg reflector reflecting a portion of the optical spectrum of the optical output back into the ring laser.

5. An RF generator according to claim 1, in which the ring laser includes a 2×2 optical coupler.

6. An RF generator according to claim 1, in which the phase modulator modulates at a frequency substantially the same as a round-trip frequency of the ring laser or a sub-multiple thereof.

7. An RF generator according to claim 1, in which the phase modulator imparts a constant phase shift.

8. An RF generator according to claim 1, in which the phase modulator imparts a time-varying phase shift.

9. An RF generator according to claim 1, in which the radio frequency signal is in the microwave wavelength range.

10. An RF generator according to claim 1, in which the radio frequency signal is in the millimeter wavelength range.

11. An RF generator according to claim 1, comprising fibre optic components.

12. An RF generator according to claim 1, comprising a photonic integrated circuit.

13. An RF generator according to claim 1, comprising discrete optical components.

14. A method of generating a tunable radio frequency signal comprising the steps of:
generating two mutually-coherent counter-propagating optical signals in a bi-directional ring laser:
imparting a phase shift to at least one of the two optical signals so as to produce a predetermined difference in the frequency of the two optical signals; and,
heterodyning the two optical signals at a photodetector so as to produce a radio frequency signal in dependence on the difference in frequency of the two optical signals.

15. A method according to claim 14, further comprising the step of mode-locking the bi-directional ring laser.
